(19) United States
(12) Patent Application Publication
(10) Pub. No.: US 2004/0088395 A1
(43) Pub. Date: May 6, 2004

(54) Method for probing a server

(76) Inventors: Timothy O'Konski, Palo Alto, CA (US); Ashish Karkare, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/285,036

(22) Filed: Oct. 30, 2002

(51) Int. Cl. G06F 15/173

(52) U.S. Cl. 709/223

(57) ABSTRACT

A method for probing a server. A message comprising a flag is generated, wherein the message is deliberately incomprehensible by the server and wherein the flag comprising a requirement of the server such that provided the server does not satisfy the requirement, the server must generate a reply. The message comprising the flag is transmitted to the server. The reply is received from the server in response to the requirement having not been satisfied.

### FIELD OF INVENTION

Various embodiments of the present invention relate to the field of server diagnostics.

### BACKGROUND OF THE INVENTION

Technological advances over the last few decades have lead to the widespread use of distributed computer networks for data communications. In order to ensure the continued viability of distributed computer networks, organizations typically put forth a substantial amount of resources to manage their networks. Network administrators typically employ a wide variety of diagnostic tools to monitor the performance and availability of a distributed computer network. One diagnostic tool, a Packet Internet Groper (ping), is a utility used to determine whether a particular server is online and whether it is cognizant. In essence, a ping is used to probe the status of a server. Typically, a ping is used to test and debug a network by transmitting a packet to the server and waiting for a reply. Timing information, such as round-trip time, may be compiled to provide diagnostic evaluations of the reliability of the server.

The World Wide Web Consortium (W3C) is an international organization that develops common protocols that promote the evolution and ensure interoperability of the World Wide Web and Web-based technologies. In an effort to provide a way for applications to communicate with each other of a distributed computer network independent of platform, the W3C developed Simple Object Access Protocol (SOAP). Simple Object Access Protocol (SOAP) is an Extensible Markup Language (XML) based protocol for exchange of information in a decentralized, distributed environment. Because SOAP promotes platform-independent communication, SOAP is expected to become widely used to invoke services throughout the Web.

In order to monitor performance of a SOAP server, a number of diagnostic tools may be implemented. A standard ping, as described above, is one desirable tool for use in providing diagnostic support to a SOAP server. However, current ping utilities for use in probing a SOAP server will not necessarily respond unless specialized software is installed as a Web service on the SOAP server.

Unfortunately, there are a number of drawbacks associated with current ping utilities. For one, ping utilities requiring special instrumentation are SOAP server dependent, and are tied to a particular vendor's implementation and administration of the server. Furthermore, some ping utilities require the use of specialized middleware installed on the SOAP server. Also, current ping utilities may require a network transport or language specific capability or instrumentation.

All current ping utilities for use in probing SOAP servers require specialized software installed on the SOAP server. Therefore, all current ping utilities fail to operate properly in a platform-independent environment without specialized configuration and/or administration capabilities. Furthermore, using a ping utility to probe the status of a SOAP server without specialized software will only provide a response from the networking layer, but will not provide information indicating whether a SOAP server is present or whether it is cognizant.

### SUMMARY OF THE INVENTION

Various embodiments of the present invention, a method for probing a server, are presented. In one embodiment, a message comprising a flag is generated, wherein the message is deliberately incomprehensible by the server and wherein the flag comprises a requirement of the server such that provided the server does not satisfy the requirement, the server must generate a reply. The message comprising the flag is transmitted to the server. The reply is received from the server in response to the requirement having not been satisfied.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary client device upon which embodiments of the present invention may be practiced.

FIG. 2 is a block diagram of an exemplary system upon which embodiments of the present invention may be practiced.

FIG. 3 is a flow chart illustrating steps in a process for probing a server in accordance with one embodiment of the present invention.

FIG. 4 is a flow chart illustrating steps in a process for probing a Simple Object Access Protocol (SOAP) server in accordance with one embodiment of the present invention.

FIG. 5 is a block diagram illustrating data flow of a system for probing a SOAP server in accordance with one embodiment of the present invention.

### BEST MODE(S) FOR CARRYING OUT THE INVENTION

Reference will now be made in detail to various embodiments of the invention, examples of which are illustrated in the accompanying drawings. While the invention will be described in conjunction with various embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

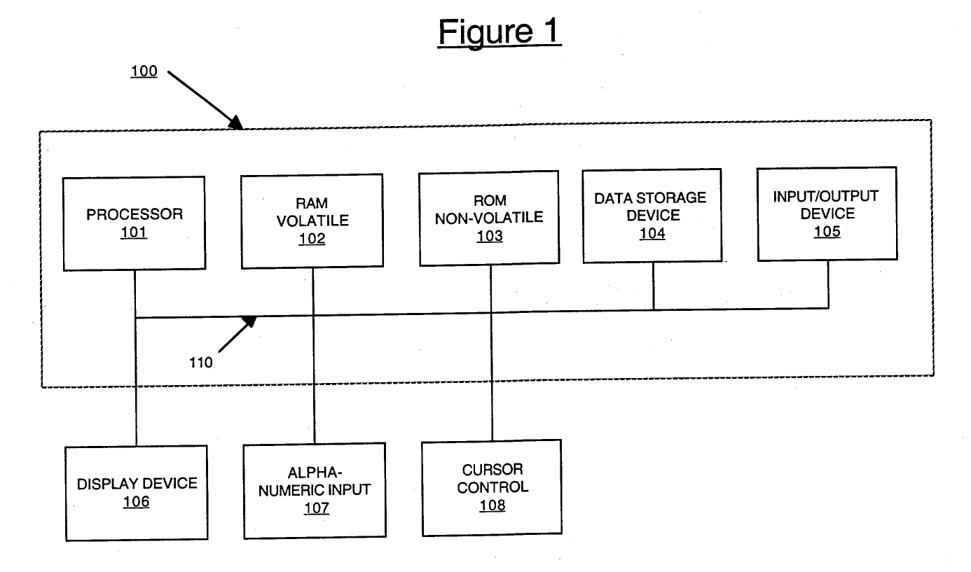

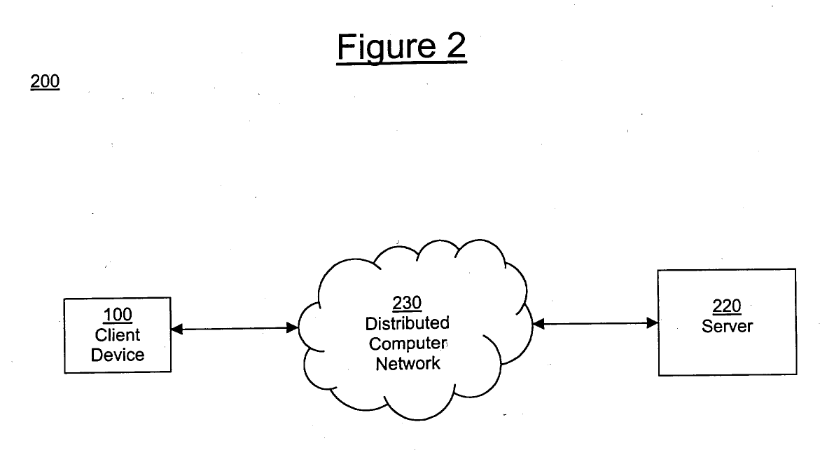

Refer now to FIG. 1, which illustrates an exemplary client device 100 upon which embodiments of the present invention may be practiced. In one embodiment, client device 100 is a computer system. Client device 100 comprises bus 110 for communicating information, processor 101 coupled with bus 110 for processing information and instructions, random access (volatile) memory (RAM) 102 coupled with bus 110 for storing information and instructions for processor 101, read-only (non-volatile) memory (ROM) 103 coupled with bus 110 for storing static information and instructions for processor 101, data storage device 104 such as a magnetic or optical disk and disk drive coupled with bus 110 for storing information and instructions, and input/output (I/O) device 105 coupled with bus 110 for coupling client device 100 to a computer network (e.g., distributed computer network 230 of FIG. 2). It should be appreciated that I/O device 105 comprises a transmitter for transmitting data over a computer network and a receiver for receiving data over a computer network.

Client device 100 may also comprise an optional user output device such as display device 106 coupled to bus 110 for displaying information to the computer user, an optional user input device such as alphanumeric input device 107 including alphanumeric and function keys coupled to bus 110 for communicating information and command selections to processor 101, and an optional user input device such as cursor control device 108 coupled to bus 110 for communicating user input information and command selections to processor 101.

FIG. 2 is a block diagram of an exemplary system 200 upon which embodiments of the present invention may be practiced. As depicted in FIG. 2, system 200 comprises client device 100 (e.g., client device 100 of FIG. 1) and server 220 communicatively coupled via distributed computer network 230. In one embodiment, client device 100 and server 220 are configured to communicate over a platform-independent protocol. In one embodiment, the platform-independent protocol is Simple Object Access Protocol (SOAP). It should be appreciated that any version of SOAP may be implemented (e.g., SOAP 1.1).

Referring still to FIG. 2, distributed computer network 230 includes well know network technologies. For example, distributed computer network 230 can be implemented using LAN technologies (e.g., Ethernet, Tokenring, etc.), the Internet, or other wired or wireless network technologies. The communications links between client device 100 and server 220 can be implemented using, for example, a telephone circuit, communications cable, optical cable, wireless link, or the like.

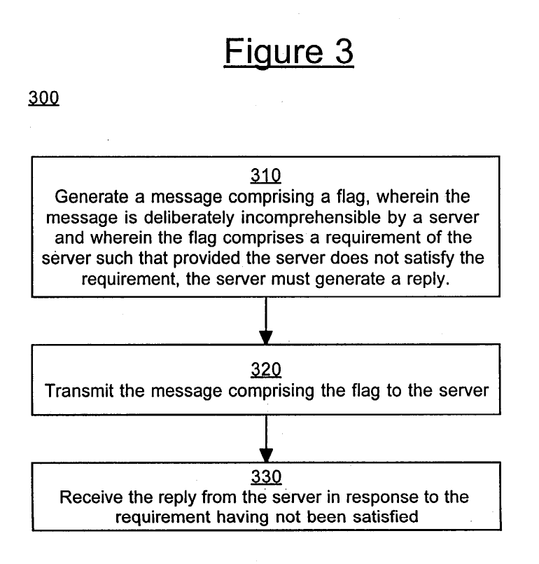

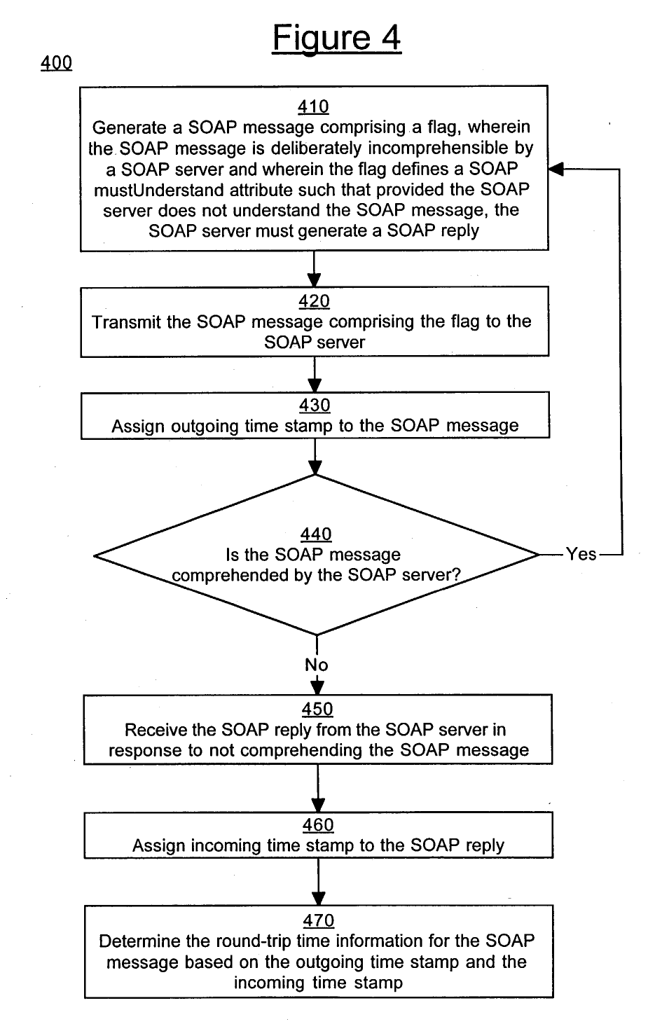

It should be appreciated that the embodiment of the present invention depicted in FIG. 2 (e.g., system 200) is implemented as a software based process cooperatively executing on the respective computer system platforms of both client device 100 and server 220. In one embodiment, client device 100 is configured to perform diagnostics on server 220. In one embodiment, client device 100 performs a method for probing server 220 (e.g., process 300 of FIG. 3 or process 400 of FIG. 4). Client 100 communicates with server 220 via the communications protocols of distributed computer network 230.

With reference to FIG. 1, in one embodiment, processor 101 is operable to generate a message comprising a flag to a server (e.g., server 220 of FIG. 2). The message generated is deliberately incomprehensible by the server. The flag comprises a requirement of the server such that provided the server does not satisfy the requirement, the server must transmit a reply to client device 100. The transmitter of I/O device 105 is operable to transmit the message comprising the flag to the server. The receiver is operable to receive a reply from the server in response to the requirement having not been satisfied.

In one embodiment, the server is a SOAP server, the message is a SOAP message and the reply is a SOAP reply. In one embodiment, the defines a SOAP “mustUnderstand” attribute requiring the SOAP server to transmit the SOAP reply provided the SOAP server does not comprehend the SOAP message. It should be appreciated that the mustUnderstand attribute is defined within the SOAP (e.g., W3C SOAP 1.1—8 May 2000, Section 4.2.3 mustUnderstand Attribute; and W3C SOAP Version 1.2 Part 0: Primer section 2.1 Soap Messages), and is required in all compliant SOAP servers, regardless of their version (e.g. SOAP 1.1, SOAP 1.2 DRAFT). In one embodiment, the mustUnderstand attribute is set to a value of “1” (e.g., true).

FIG. 3 is a flow chart illustrating steps in a process 300 for probing a server in accordance with one embodiment of the present invention. In one embodiment, process 300 is carried out by processors and electrical components under the control of computer readable and computer executable instructions. Although specific steps are disclosed in process. 300, such steps are exemplary. That is, the embodiments of the present invention are well suited to performing various other steps or variations of the steps recited in FIG. 3. As depicted in FIG. 3, process 300 diagrams the operating process of probing a server by a client device, for example, client device 100 of FIG. 1.

At step 310, a message comprising a flag is generated. In one embodiment, a client device (e.g., client device 100 of FIG. 1) generates the message. The message is generated so as to be deliberately incomprehensible by a server receiving the message. The flag comprises a requirement of the server such that provided the server does not satisfy the requirement, the server must generate a reply. It should be appreciated that the message is created in a platform-independent protocol. In one embodiment, the message is a SOAP message.

At step 320, the message comprising the flag to is transmitted to the server. In one embodiment, the message is transmitted by an I/O device (e.g., I/O device 105 of FIG. 1) of the client device for transmission over a network (e.g., distributed computer network 230 of FIG. 2). In one embodiment, the message is assigned an outgoing time stamp upon its transmission. In one embodiment, the outgoing time stamp is placed in the header of the message.

In one embodiment, provided the server satisfies the requirement, a second message comprising the flag is generated. As with the message generated at step 310, the second message is generated so as to be deliberately incomprehensible by a server receiving the second message. Also, the flag comprises a requirement of the server such that provided the server does not satisfy the requirement, the server must generate a reply. The second message comprising the flag is then transmitted to the server. It should be appreciated that provided the second message is also comprehended, deliberately incomprehensible messages will continue to be generated until a message is transmitted that is not comprehended by the server.

At step 330, the reply is received from the server in response to the requirement having not been satisfied. In one embodiment, the reply is received by an I/O device (e.g., I/O device 105 of FIG. 1) over a network (e.g., distributed computer network 230 of FIG. 2). It should be appreciated that the reply is based on the message such that the reply identifies the particular message sent to the server, as distinguishable from other messages sent to the server. In one embodiment, the reply is assigned an incoming time stamp upon its receipt. In one embodiment, the incoming time stamp is placed in the header of the message.

In one embodiment, round-trip timing information for the message is determined based on the outgoing time stamp and the incoming time stamp. Subtracting the outgoing time stamp from the incoming time stamp provides a round-trip time for the message. The round-trip time may be used to monitor performance of the server. In one embodiment, the timing information and statistical error models are applied to provide both diagnostic and reliability predictions about the specific server.

FIG. 4 is a flow chart illustrating steps in a process for probing a SOAP server in accordance with one embodiment of the present invention. In one embodiment, process 400 is carried out by processors and electrical components under the control of computer readable and computer executable instructions. Although specific steps are disclosed in process 400, such steps are exemplary. That is, the embodiments of the present invention are well suited to performing various other steps or variations of the steps recited in FIG. 4. As depicted in FIG. 4, process 400 diagrams the operating process for probing a SOAP server by a client device, for example, client device 100 of FIG. 1.

At step 410, a SOAP message comprising a flag is generated. In one embodiment, a client device (e.g., client device 100 of FIG. 1) generates the SOAP message. The SOAP message is generated so as to be deliberately incomprehensible by a SOAP server receiving the SOAP message. The flag defines a SOAP “mustUnderstand” attribute requiring the SOAP server to transmit a SOAP reply provided the SOAP server does not comprehend the SOAP message. As described above, it should be appreciated that the mustUnderstand attribute is defined within the SOAP specification, and is required in all compliant SOAP servers. In one embodiment, the mustUnderstand attribute is set to a value of “1” (e.g., true).

At step 420, the SOAP message comprising the flag to is transmitted to the SOAP server. In one embodiment, the SOAP message is transmitted by an I/O device (e.g., I/O device 105 of FIG. 1) of the client device for transmission over a network (e.g., distributed computer network 230 of FIG. 2). In one embodiment, as shown at step 430, the SOAP message is assigned an outgoing time stamp upon its transmission. In one embodiment, the outgoing time stamp is placed in the header of the SOAP message. It should be appreciated that step 430 is optional.

At step 440, it is determined whether the SOAP server comprehends the SOAP message. Provided the SOAP server does comprehend the SOAP message, a second SOAP message comprising a flag is generated. As with the SOAP message generated at step 410, the second SOAP message is generated so as to be deliberately incomprehensible by a SOAP server receiving the second SOAP message. Also, the flag defines a SOAP “mustUnderstand” attribute requiring the SOAP server to transmit a SOAP reply provided the SOAP server does not comprehend the second SOAP message. It should be appreciated that provided the second SOAP message is also comprehended-by the SOAP server, steps 410 through 440 will continue to be performed until a SOAP message is transmitted that is not comprehended by the SOAP server.

Provided the SOAP server does not comprehend the SOAP message, as shown at step 450, a SOAP reply is received from the server. It should be appreciated that the SOAP reply is generated and transmitted by the SOAP server in response to the flag defining the mustUnderstand attribute of the SOAP message. In one embodiment, the SOAP reply is received by an I/O device (e.g., I/O device 105 of FIG. 1) over a network (e.g., distributed computer network 230 of FIG. 2). It should be appreciated that the SOAP reply is based on the SOAP message such that the SOAP reply identifies the particular SOAP message sent to the SOAP server, as distinguishable from other SOAP messages sent to the SOAP server. In one embodiment, as shown at step 460, the SOAP reply is assigned an incoming time stamp upon its receipt. In one embodiment, the incoming time stamp is placed in the header of the SOAP reply. It should be appreciated that step 460 is optional.

At step 470, round-trip timing information for the SOAP message is determined based on the outgoing time stamp and the incoming time stamp. Subtracting the outgoing time stamp from the incoming time stamp provides a round-trip time for the SOAP message. The round-trip time may be used to monitor performance of the server. In one embodiment, the timing information and statistical error models are applied to provide both diagnostic and reliability predictions about the specific SOAP server. It should be appreciated that step 470 is optional.

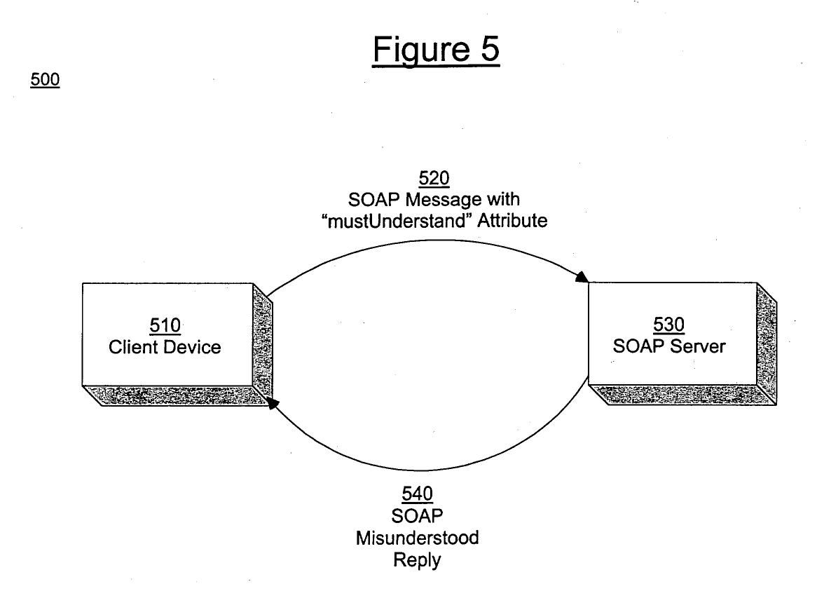

FIG. 5 is a block diagram illustrating data flow of a system 500 for probing a SOAP server in accordance with one embodiment of the present invention. System 500 comprises client device 510 and SOAP server 530 that are communicatively coupled over a distributed computer network (e.g., distributed computer network 230 of FIG. 2).

Client device 510 generates a SOAP message 520 that is deliberately incomprehensible by SOAP server 530. SOAP message 520 comprises a SOAP “mustUnderstand” attribute flag. The SOAP mustUnderstand attribute requires SOAP server 530 to reply to SOAP message 520 provided SOAP message 520 is not comprehended by SOAP server 530. SOAP message 520 is transmitted to SOAP server 530. In one embodiment, SOAP message 520 is transmitted by an I/O device (e.g., I/O device 105 of FIG. 1) of client device 510 for transmission over a network (e.g., distributed computer network 230 of FIG. 2) to SOAP server 530. In one embodiment, SOAP message 520 is assigned an outgoing time stamp upon its transmission. In one embodiment, the outgoing time stamp is placed in the header of SOAP message 520.

SOAP server 530 receives SOAP message 520 for processing. Because SOAP message 520 is deliberately incomprehensible by SOAP server 530, SOAP server 530 does not comprehend message 520. Furthermore, because SOAP message 520 comprises a SOAP “mustUnderstand” attribute flag, server 530 must transmit a reply to client device 510 indicating that message 520 was not comprehended. SOAP server 530 generates SOAP misunderstood reply 540 and transmits SOAP misunderstood reply to client device 510.

Client device 510 receives SOAP misunderstood reply 540. In one embodiment, SOAP misunderstood reply 540 is received by an I/O device (e.g., I/O device 105 of FIG. 1) of client device 510 over a network (e.g., distributed computer network 230 of FIG. 2). It should be appreciated that SOAP misunderstood reply 540 is based on SOAP message 520 such that SOAP misunderstood reply 540 identifies SOAP message 520 in particular, as distinguished from other SOAP messages sent to SOAP server 530. In one embodiment, SOAP misunderstood reply 540 is assigned an incoming time stamp upon its receipt. In one embodiment, the incoming time stamp is placed in the header of SOAP misunderstood reply 540.

In one embodiment, client device 510 determines round-trip timing information for SOAP message 520 based on the outgoing time stamp and the incoming time stamp. Subtracting the outgoing time stamp from the incoming time stamp provides a round-trip time for SOAP message 520. The round-trip time may be used to monitor performance of SOAP server 530. In one embodiment, the timing information and statistical error models are applied to provide both diagnostic and reliability predictions about the SOAP server 530.

Various embodiments of the present invention, a method for probing a server, are thus described. While the present invention has been described in particular embodiments, it should be appreciated that the present invention should not be construed as limited by such embodiments, but rather construed according to the below claims.

What is claimed is:

1. A method for probing a server, said method comprising:
generating a message comprising a flag, wherein said message is deliberately incomprehensible by said server and wherein said flag comprising a requirement of said server such that provided said server does not satisfy said requirement, said server must generate a reply;
transmitting said message comprising said flag to said server; and
receiving said reply from said server in response to said requirement having not been satisfied.

2. The method as recited in claim 1 wherein said server is a Simple Object Access Protocol (SOAP) server, said message is a SOAP message and said reply is a SOAP reply.

3. The method as recited in claim 2 wherein said flag defines a SOAP mustUnderstand attribute requiring said SOAP server to transmit said SOAP reply provided said SOAP server does not comprehend said SOAP message.

4. The method as recited in claim 3 wherein said SOAP reply is generated in response to said SOAP server not comprehending said SOAP message.

5. The method as recited in claim 1 further comprising:
assigning said message an outgoing time stamp upon transmission of said message; and
assigning said reply an incoming time stamp upon receipt of said reply.

6. The method as recited in claim 5 further comprising determining round-trip timing information for said message based on said outgoing time stamp and said incoming time stamp.

7. The method as recited in claim 1 further comprising:
provided said requirement is satisfied by said server, generating a second message comprising said flag, wherein said second message is deliberately incomprehensible by said server; and
transmitting said second message comprising said flag to said server.

8. A computer-readable medium having computer-readable program code embodied therein for causing a computer system to perform a method for probing a server, said method comprising:
generating a deliberately incomprehensible message, wherein a flag of said message causes a server to generate a reply provided said message is not comprehended by said server;
transmitting said message to said server; and
receiving said reply from said server in response to said server not comprehending said message.

9. The computer-readable medium as recited in claim 8 wherein said server is a Simple Object Access Protocol (SOAP) server, said message is a SOAP message and said reply is a SOAP reply.

10. The computer-readable medium as recited in claim 9 wherein said flag defines a SOAP mustUnderstand attribute requiring said SOAP server to transmit said SOAP reply provided said SOAP server does not comprehend said SOAP message.

11. The computer-readable medium as recited in claim 10 wherein said SOAP reply is generated in response to said SOAP server not comprehending said SOAP message.

12. The computer-readable medium as recited in claim 8 further comprising:
assigning said message an outgoing time stamp upon transmission of said message; and
assigning said reply an incoming time stamp upon receipt of said reply.

13. The computer-readable medium as recited in claim 12 further comprising determining round-trip timing information for said message based on said outgoing time stamp and said incoming time stamp.

14. The computer-readable medium as recited in claim 8 further comprising:
provided said server does comprehend said message, generating a second deliberately incomprehensible message comprising said flag; and
transmitting said second message to said server.

15. A computer system comprising:
a bus;
a computer-readable memory coupled to said bus;
a processor coupled to said bus, said processor operable to generate a message comprising a flag, wherein said message is deliberately incomprehensible by a server and wherein said flag comprises a requirement of said server such that provided said server does not satisfy said requirement, said server must transmit a reply to said computer system;
a transmitter coupled to said bus, said transmitter operable to transmit said message comprising said flag to said server; and
a receiver coupled to said bus, said receiver operable to receive said reply from said server in response to said requirement having not been satisfied.

16. The computer system as recited in claim 15 wherein said server is a Simple Object Access Protocol (SOAP) server, said message is a SOAP message and said reply is a SOAP reply.

17. The computer system as recited in claim 16 wherein said flag defines a SOAP mustUnderstand attribute requiring said SOAP server to transmit said SOAP reply provided said SOAP server does not comprehend said SOAP message.

18. The computer system as recited in claim 17 wherein said SOAP reply is generated in response to said SOAP server not comprehending said SOAP message.

19. The computer system as recited in claim 15 further comprising a time stamp assignor coupled to said bus, said time stamp assignor operable to assign said message an outgoing time stamp upon transmission of said message and operable to assign said reply an incoming time stamp upon receipt of said reply.

20. The computer system as recited in claim 15, wherein provided said requirement is satisfied by said server, said processor is operable to generate a second message comprising said flag, wherein said second message is deliberately incomprehensible by said server and wherein said transmitter is operable to transmit said second message comprising said flag to said server.
